(19) United States
(12) Patent Application Publication
(10) Pub. No.: US 2008/0139030 A1
(43) Pub. Date: Jun. 12, 2008

(54) ELECTRICAL SOCKET ASSEMBLY FOR TANKER TRUCK OVERFILL PREVENTION SYSTEM

(75) Inventor: Nicholas P. Milo, Saugus, MA (US)

Correspondence Address: LAW OFFICES OF PAUL E. KUDIRKA, 40 BROAD STREET, SUITE 300, BOSTON, MA, 02109, US

(73) Assignee: Scully Signal Company, Wilmington, MA (US)

(21) Appl. No.: 11/608,510

(22) Filed: Dec. 8, 2006

(51) Int. Cl. H01R 13/52; H01R 13/62; H01R 24/00

(52) U.S. Cl. 439/277; 439/312; 439/626

(57) ABSTRACT

In an improved electrical socket assembly a socket ring and contact block assembly are affixed to a faceplate by two snap rings. An outer snap ring fits into a groove cut into the outer end of the contact block. This snap ring bears against a shoulder on the inner surface of the socket ring and prevents the contact block from being pushed through the socket ring. The contact block extends through socket ring and further through the face plate where it is secured by an inner snap ring that bears against the inner surface of the face plate. The socket ring and the contact block are thus affixed to the face plate without using any bolts which can corrode and make replacement of the socket ring difficult.

### BACKGROUND

This invention relates to electrical socket assemblies used in overfill prevention systems for liquid carrying tanker trucks. Tanker trucks, such as those used to carry petroleum products from storage depots to service stations, are typically loaded at the storage depot from a loading rack or island. Each tank, or compartment, on the truck is loaded from the bottom expelling air into a vent system located at the top of the compartment. Because the compartment are typically fabricated of metal and sealed, the fluid level in a tank cannot be visually checked to determine whether the tank is full. Therefore, it is relatively easy for the tank to be overfilled causing the liquid product to overflow into the vent system at the top of the tank, thereby potentially releasing the product into the environment with accompanying environmental damage. In order to prevent such overflows, electrical overflow prevention systems have been designed to detect an overflow condition and automatically stop the filling process.

A typical overflow prevention system uses a sensor located in each compartment. The sensor senses when the liquid level in the compartment is approaching an overfill condition and electrically communicates with the loading rack to stop the filling process. To electrically connect each sensor to the loading rack, the sensor is wired to an electrical socket assembly mounted on the truck. When the truck arrives at the loading rack, a plug connected to the end of a cable extending from an overfill monitor located at the loading rack is attached to the socket assembly on the truck to connect the sensors on the truck to an overfill prevention circuit at the loading rack.

The socket assembly mounted on each truck typically includes an electrically insulating cylindrical contact block, in turn, containing a plurality of electrically conductive pins which are wired to the sensors and ground. The contact block is surrounded by a socket ring. The socket ring and contact block are mounted to a face plate which is, in turn, secured to a housing in which the wires from the sensors terminate and are connected to the pins. The housing, face plate and socket assembly protects the sensor wires from weather conditions.

The plug assembly is cup-shaped with spring-loaded pins and fits over the socket ring. The outer surface of the socket ring has several “J-shaped” slots which receive studs extending from the inside of the plug. When the plug is pushed over the socket ring, the studs on the inside of the plug slide into the “J” shaped slots of the socket ring. The plug is then rotated so that the studs slide into the short leg of the “J-shaped” slots and the studs are held in position by the spring tension of the pins. In the rotated position, the pins in the plug line up with the pins in the contact block and establish electrical contact.

When they are new, the plug and socket assembly function well, however, the truck on which the socket is mounted may be loaded thousands of times and each time a loading is accomplished the plug and socket assembly must be connected and unconnected. Over time the “J” shaped slots on the outside of the socket ring experience wear when the plug is slid over them. Eventually, the wear becomes sufficient that the pins in the plug and the pins in the socket assembly do not maintain good electrical contact and no longer are able to function properly. Consequently, the socket ring with the worn “J” shaped slots must be replaced.

There are several problems associated with replaceable socket rings. First, the socket ring can be made of several materials, but is typically made of machined stainless steel and the cost of a new socket ring can be considerable. In addition, the socket ring is typically bolted to the face plate by bolts that pass through the face plate into threaded holes at the back of the socket ring. Thus, the socket ring can be separated from the face plate by removing the bolts. Typically, the bolts are also stainless steel. However, over time and due to the influences of water and dirt, the socket and bolts can corrode and fuse, making it extremely difficult to remove the bolts in order to replace the socket. In addition, the bolts are sometime cross-threaded during assembly, again making it difficult to remove them the next time that the socket ring must be replaced. In order to overcome this difficulty, lubricants have been applied to the bolts before inserting them into the socket ring, but the lubricant also makes the assembly prone to loosening over time.

Further, in some conventional socket assemblies the socket ring has a shoulder on its inner surface that engages another shoulder or lip on the contact block in order to prevent the contact block from being pushed through the socket ring when the plug is pressed over the socket ring. In these assemblies, in order to remove and replace a worn socket ring, the pins in the contact block must be detached from the wires so that the contact block and pins can be pulled out of, and free, the socket ring. Since there are typically several wires and pins, the possibility of an error when the wires and pins are reconnected is significant.

In other conventional socket assemblies, the socket ring does not have a shoulder which prevents the contact block from being pushed through the ring. Instead, a shoulder on the face plate prevents the contact block from being pushed through the socket ring. However, with a socket assembly of this type, the bolts holding the socket ring to the face plate must still be removed before the socket ring can be removed and replaced. Thus, the aforementioned problems with the bolts are still present in this design.

Still another problem occurs because water and other liquids enter the housing through the contact block and corrode the wires and electronic apparatus within the housing. In particular, the contact pins are typically press-fitted into the contact block. Although the pins fit very tightly into the contact block, nevertheless leakage of water and other liquids typically occurs at this point.

A still further problem occurs in electrical socket assemblies that include truck identification modules. A truck identification module contains an interface, an electronics package including a memory that generates a code which uniquely identifies a particular tanker truck and a battery to power the electronics package. The code generated by the module can be passed through the electrical socket assembly to the loading station so that the truck can be identified to the loading station for billing purposes. Typically, the entire module is sealed in order to prevent tampering with the truck identification code. However, because the module contains all of the identification apparatus, when the battery runs out, the entire module must be replaced, resulting in a significant expense.

### SUMMARY

In accordance with the principles of the invention, an improved electrical socket assembly is provided which solves the aforementioned problems. In one embodiment, the socket ring and contact block of an electrical socket assembly are affixed to the faceplate by two snap rings. An outer snap ring fits into a groove cut into the outer end of the contact block. This snap ring bears against a shoulder on the inner surface of the socket ring and prevents the contact block from being pushed through the socket ring. A roll pin fits into a hole formed at the interface of the contact block and the socket ring and prevents the contact block from rotating relative to the socket ring. The contact block then extends through socket ring and further through the face plate where it is secured by an inner snap ring that bears against the inner surface of the face plate. The roll pin also extends through a cutout in the faceplate and prevents relative rotation between the contact block and the faceplate. The socket ring and the contact block are thus affixed to the face plate without using any bolts.

In another embodiment, each contact pin is sealed by an elastomeric O-ring to the contact block at the outer end of the pin. The pins are inserted into the contact block and secured by setscrews. Thus, the entire contact block, including all of the contact pins is weather-tight, obviating any corrosion problems.

In a still further embodiment, an air brake control is comprised of a commercially-available air poppet valve and a valve extension. The commercially-available valve reduces the cost of the air brake control while the valve extension increases the travel distance of the commercially-available valve so that the valve is reliably activated when a plug is attached to the socket assembly, but the valve actuator pin does not interfere when the plug is attached.

In yet another embodiment, the socket assembly incorporates a two-part truck identification module. The electronics portion of the module is located in a secure pocket that is molded into a portion of the socket assembly housing and permanently affixed in the pocket by potting compound or epoxy thereby preventing the module from being tampered with. However, the battery which powers the module in located outside of the secure pocket and connected to the electronics by wires. The battery can therefore be easily replaced without replacing the entire unit.

### BRIEF DESCRIPTION OF THE DRAWINGS

FIG. 1 of the drawing is an exploded perspective view of one embodiment of the electrical socket assembly showing the socket ring, contact block, face plate and housing.

FIG. 2 is a plan view of the embodiment shown in FIG. 1 with a dust cap installed.

FIG. 3 is a cross-sectional view of the assembly taken along the section line A-A shown in FIG. 2.

FIG. 4 is a perspective view of a contact block assembly and roll pin.

FIG. 5 is a side view of the contact block assembly and socket ring

FIG. 6 is a rear view of the contact block and socket ring assembly showing the ferrules for connecting electrical wires to the socket.

FIG. 7 is a detail view of the area “B” shown in FIG. 8 that illustrates the outer snap ring assembly.

FIG. 8 is a cross-sectional view of the contact block and socket ring assembly taken along the section lines A-A shown in FIG. 6.

FIG. 9 is a perspective view of an air brake control that employs an extension to provide an increased operating range.

FIG. 10 is a partial cutaway drawing illustrating the components inside the extension.

FIG. 11 is an exploded diagram showing the components of the air brake control.

FIG. 12 is a perspective view of the faceplate and interface incorporating a secure pocket for a truck identification module.

FIG. 13 is a perspective view of the housing with the faceplate removed in order to show the secure pocket and the battery for the truck identification module.

### DETAILED DESCRIPTION

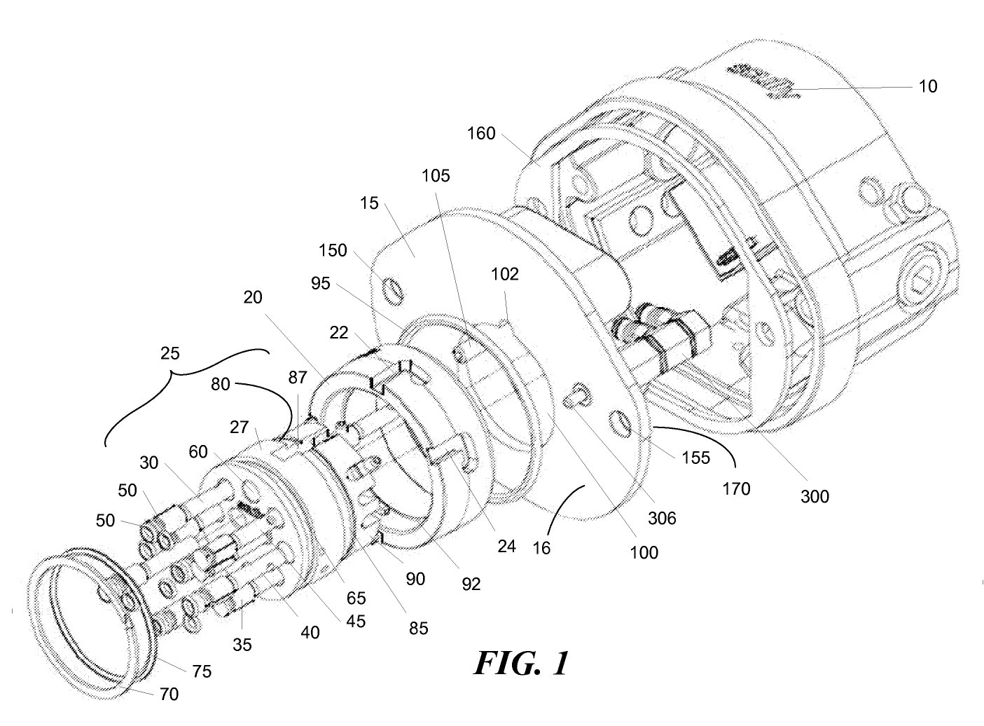

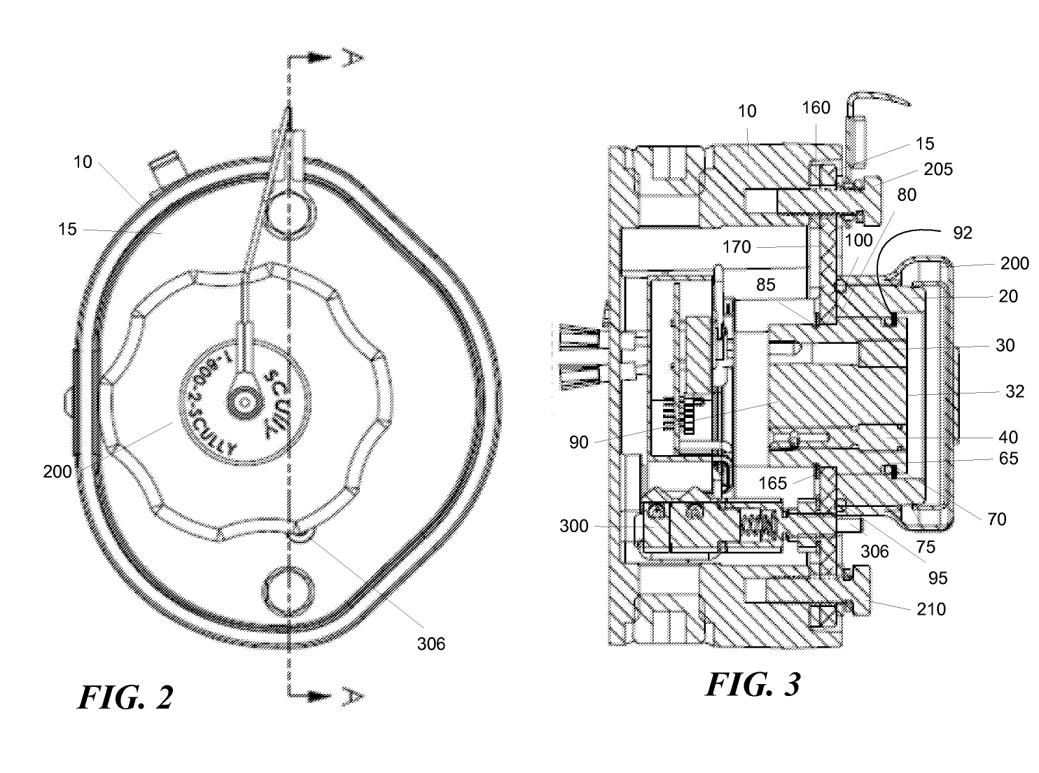

FIGS. 1-8 show one embodiment of an electrical socket assembly constructed in accordance with the principles of the invention. The main elements of the assembly comprise a housing 10, face plate 15, socket ring 20 and contact block assembly 25. The socket ring 20 and contact block assembly 25 can be covered by a dust cap 200 when not in use.

The housing 10 made be fabricated from any suitable material, such as cast aluminum or other cast metal. In a similar manner, the faceplate 15 may also be made of cast metal. An elastomeric gasket 160 forms a liquid-tight seal between the face plate 15 and the housing 10.

The socket ring 20 may also be made of a cast metal, such as aluminum or stainless steel. Typically, the “J” shaped slots 22 and 24 are machined into the outer surface of the ring in order to maintain accurate tolerances. In one embodiment, the socket ring is made of a zinc material, such as ZA-3, and plated with chrome in order to provide a hard ring surface. It has been found that this chrome-plated zinc ring has a surface hardness equivalent to stainless steel, but can be fabricated at a fraction of the cost necessary to fabricate a stainless steel ring.

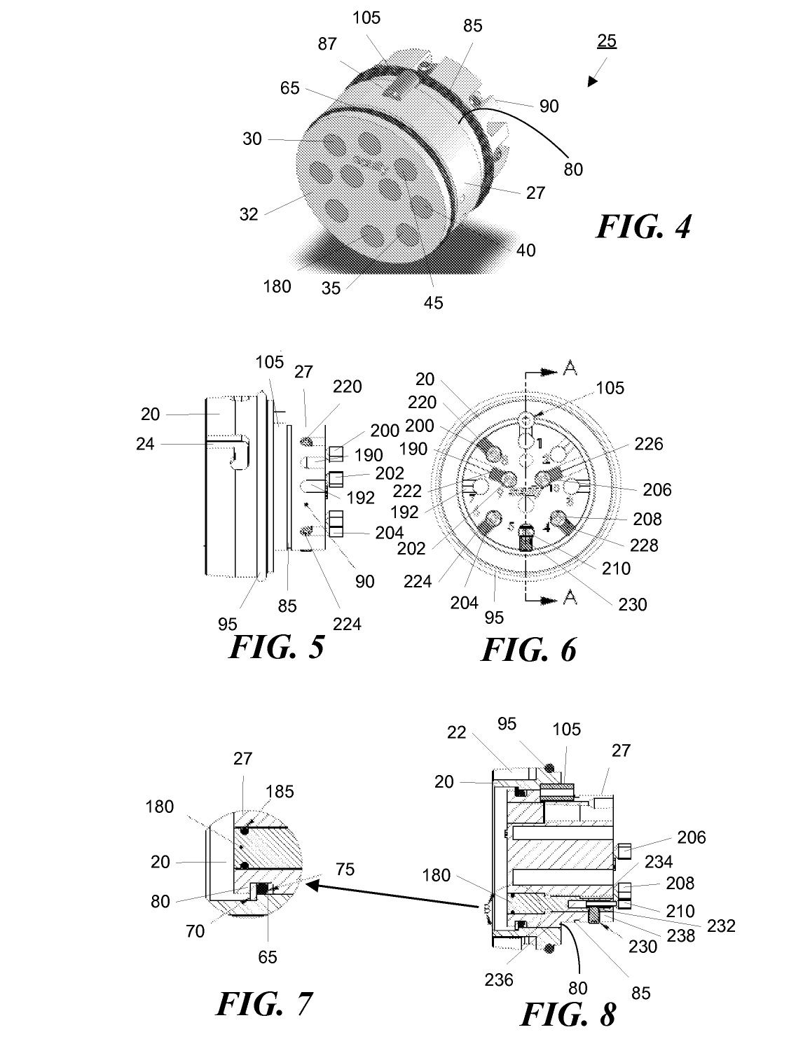

The contact block assembly 25 is shown in more detail in the perspective view of FIG. 4 and the additional views shown in FIGS. 5-8 and comprises a body 27 fabricated from a polymeric material, such as polycarbonate. The body 27 has a plurality of pin holes, of which one is enumerated as hole 60 in FIG. 1, that pass through the length of the body 27. Each hole accommodates a contact pin, such as one of pins 30, 35, 40 or 45. Each of the pins, for example pin 30, has a groove 50 which accommodates an O-ring made of an elastomeric material, such as Viton® (trademark of DuPont Performance Elastomers). The O-ring forms a seal against the inside diameter of the pin hole providing a liquid-tight seal between each pin and the contact block body 27. Details of the O-ring are also illustrated in FIG. 7, which shows an enlarged detail area “B” of FIG. 8. FIG. 7 illustrates an O-ring 185 that seals pin 180 against contact block body 27.

In accordance with the principles of the invention, the contact block body 27 is configured to mount the socket ring 20 on the faceplate 15 without the use of screws or bolts. In particular, the contact block body 27 has an outer groove 65 and an inner groove 85 cut into the outer surface of the body 27. The outer groove 65 accommodates an O-ring seal 75 and a snap ring 70 whereas the inner groove accommodates a snap ring 165 (shown in FIG. 3). In order to assemble the contact block assembly 25 and socket ring 20 to the faceplate 15. O-ring 75 is slid over the outer end 32 of contact block body 27 until it is seated in groove 65. The snap ring 70 is then expanded and slid over the outer end 32 of contact block body 27 until it is seated in groove 65 in front of O-ring 75 as shown in FIGS. 3 and 7. A roll pin 105 laid in cutout 87 of the contact block body 27 serves to prevent relative rotation between the parts of the assembly as discussed below.

Next, the contact block body 27 is slid into socket ring 20 until snap ring 70 seats against shoulder 92 formed in the inner diameter of socket ring 20. The snap ring 70 prevents the contact block assembly 25 from sliding through the socket ring 20. Roll pin 105 slides into a semi-circular groove in the inner diameter of socket ring 20 and prevents relative rotation between the contact block body 27 and the socket ring 20.

An elastomeric O-ring 95 is then slid over the inner end 90 of contact block body 27 so that it seats against a shoulder formed on the inner surface of socket ring 20. The inner end 90 of contact block body 27 is slid through hole 100 cut into faceplate 15 so that the O-ring seats against the outer surface 16 of faceplate 15 and shoulder 80 of contact block body 27 seats against the outer surface 16 of faceplate 15. Roll pin 105 slides through a cutout 102 in faceplate 15 and prevents relative rotation between the contact block assembly 25, socket ring 20 and faceplate 15.

Finally, snap ring 165 is expanded, slid over the inner end 90 of contact block body 27 and seated in groove 85. Snap ring 165 bears against the inner surface 170 of faceplate 15 as shown in FIG. 3 and holds the entire assembly together. Advantageously, no screws or bolts are used and, therefore, no corrosion problems occur.

The snap ring 165 allows the socket ring 20 to be easily removed and replaced without disconnecting wires from the contact block assembly 25. In particular, in order to replace the socket ring 20, the faceplate 15 is separated from the housing 10 by removing the hold down bolts 205 and 210 (FIG. 3). Then, snap ring 165 is expanded and slid over the inside end 82 of contact block body 27. Contact block body 27 can then be pulled out of faceplate 15 and slid out of socket ring 20. Then, snap ring 70 is expanded and removed. At this point, socket ring 20 can be slid over the contact block body and replaced. The foregoing procedure is then reversed in order to reassemble the unit.

FIGS. 5, 6 and 8 also illustrate the construction of the contact pins and their manner of attachment to the electrical wires. In particular, FIGS. 5, 6 and 8 show views of the inner end of the contact block assembly 25. As shown in FIGS. 5 and 6, the particular contact block assembly illustrated has ten pin holes, but only six contact pins. The remaining pin holes are filled with insulating plugs. Each pin hole has a U-shaped slot at the inner end 90 of the contact block body 27, such as slots 190 and 192. Each slot extends from the periphery of the contact block body 27 radially inward to the pin hole and is positioned to receive a setscrew that is used to hold the corresponding contact pin in position.

After contact pin 180 has been inserted into the contact block body 27, the tang of a contact ferrule is inserted into a hole bored in the inner end of the contact pin. For example, referring to FIG. 8, tang 234 of ferrule 210 is inserted into the hole 236 bored into the inner end of contact pin 180 and extending longitudinally. Each contact pin, such as contact pin 180, is provided with a small tapped transverse hole 232, which extends into longitudinal hole 236. A setscrew 230 is threaded into hole 232. Then, setscrew 230 is tightened against tang 234 thereby locking ferrule 210 into position and establishing electrical contact between ferrule 210 and pin 180. Setscrew 230 seats against the U-shaped bottom of slot 238 and prevents contact pin 180 from being withdrawn from contact block body 27. The entire assembly is therefore locked together. Each contact pin has a ferrule fastened in the same manner. Ferrules 200-210 are illustrated in FIG. 6. The setscrews 220-226 hold the corresponding contact pins in position.

FIG. 1 shows an air brake control 300 that controls the air brakes of the tanker truck in order to apply the brakes when the tanker truck is connected to the loading rack. The air brake control 300 is operated by an actuator pin 306. Actuator pin 306 is, in turn, contacted by the plug assembly from the loading rack (not shown in FIG. 1) when the plug assembly is attached to the electrical socket assembly shown in FIG. 1 in order to actuate the control. When the control 300 is actuated, it releases the air in the truck braking system and prevents the truck from moving while it is still attached to the loading rack.

It is desirable to use a commercially-available air valve for the air brake control 300 because commercially-available valves are considerably less expensive than custom-made valves. An example of such a commercially-available valve is a Clippard Minimatic model MAV-3R poppet air valve manufactured by Clippard Instrument Laboratory, Inc., Cincinnati, Ohio. Such a valve is opened when its actuator pin is pressed toward the valve body. However, in such commercially-available valves, the travel distance of the actuator pin from a position where the valve is closed to a position where the valve is open is small. Thus, it is difficult to position the valve 300 relative to the faceplate 15 in order to insure that the air brake control is actuated when an electrical plug is attached and to prevent the actuator pin from interfering with the attachment of the electrical plug to the electrical socket assembly if the actuator reaches the end of its travel distance before the plug is fully seated.

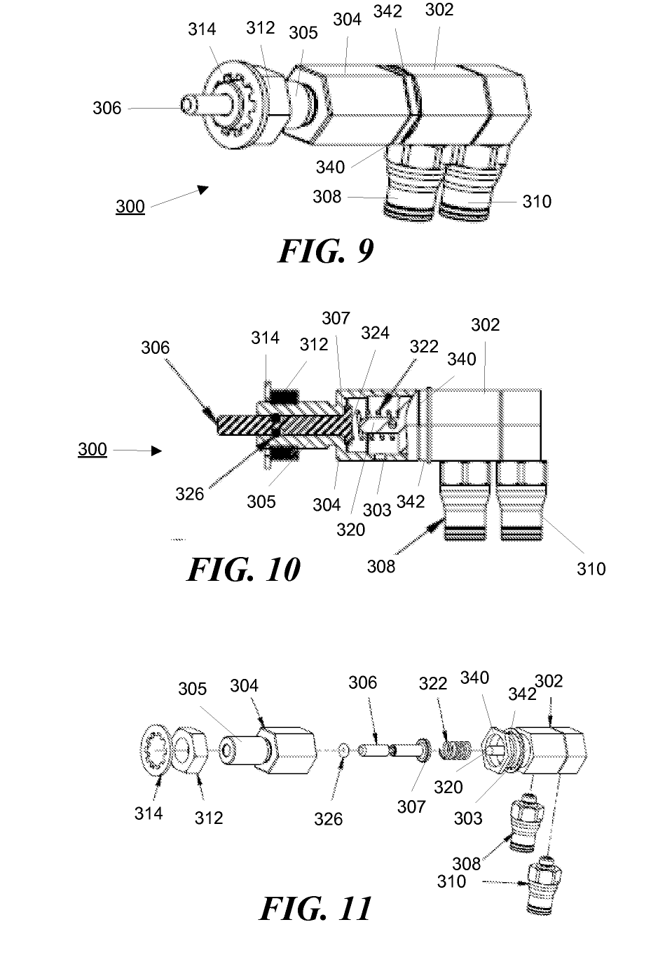

FIGS. 9-11 illustrate an air brake control that incorporates an inventive extension assembly to increase the travel length of the actuator. An increased travel length prevents the actuator from interfering with the attachment of an electrical plug to the electrical socket assembly while insuring that the air brake control is actuated when the plug is attached. The air brake control 300 comprises a commercially available air poppet valve 302, such as the aforementioned MAV-3R valve which is actuated by actuator pin 320. Valve 302 can be attached to air connections from the tanker truck via connection fittings 308 and 310. This valve also has an externally threaded nipple 303 (shown in FIG. 10) that can be used to attach the valve to another component. Threaded onto nipple 303 is an extension housing 304. A lock washer 342 and lock nut 340 can be used to make the connection between the valve 302 and the housing 304 secure.

Housing 304 has its own threaded nipple 305 which can be screwed into faceplate 15 and secured by means of lock washer 314 and lock nut 312 in order to fasten the air brake control 300 to the faceplate 15. Nipple 305 of housing 304 is hollow and receives an extension pin 306 which slides within nipple 305. Pin 306 is sealed to nipple 305 via an elastomeric O-ring 326 that fits into a groove in pin 305.

Pin 306 also has a head 307. When slid outward as far as possible, head 307 bears against the inside surface of housing 304. When the air brake control is not actuated, a spring 322 maintains the pin 306 slid outward.

In accordance with one aspect of the invention housing 304 is dimensioned so that, in the non-actuated position, spring 322 maintains a small gap 324 of predetermined width between pin head 307 and valve actuator pin 320. For example, this predetermined width might be 1/16 inch. The presence of this gap effectively increases the actuator travel distance because, when an electrical plug is attached to the electrical socket assembly, pin 306 must first travel the width of gap 324 before contacting the actuator pin 322 of valve 302 and then travel the normal actuator travel distance of the valve 302 before the valve opens. Illustratively, in the case of the model MAV-3R poppet air valve mentioned above, the 1/16 inch gap increases the overall travel distance from ⅛ inch to 3/16 inch. The increased travel distance insures that the valve 302 will be actuated when the electrical plug is installed, but the actuator pin will not interfere with the electrical plug during its installation.

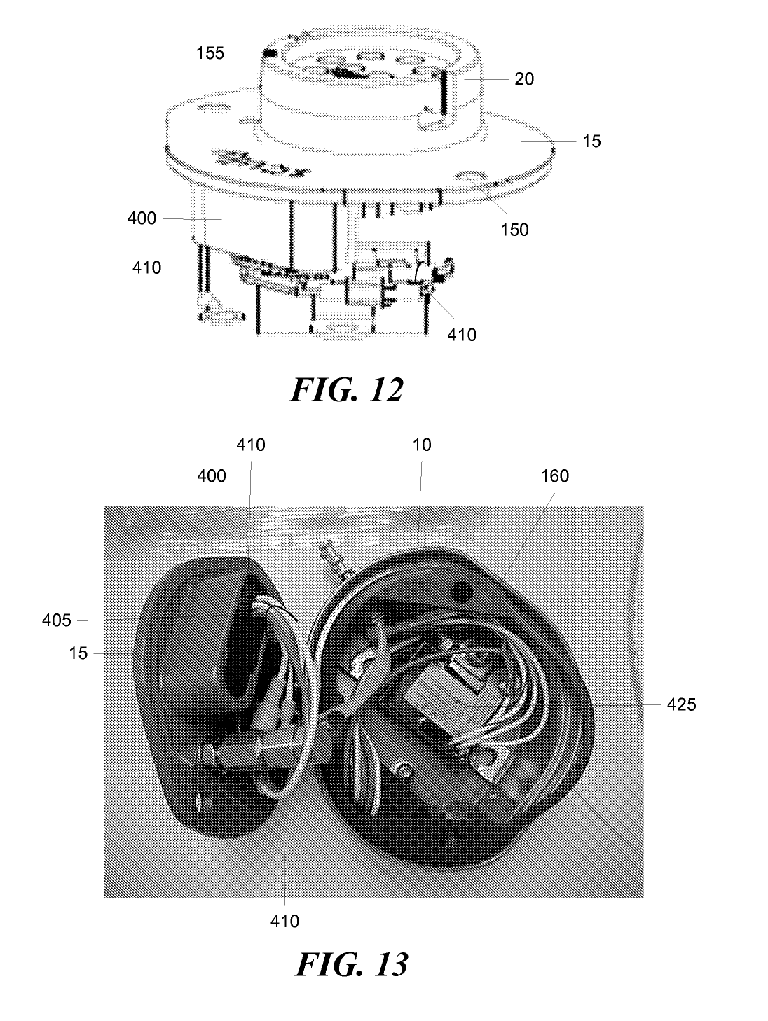

FIGS. 12 and 13 illustrate another aspect of the present invention which is useful in electronic socket assemblies that incorporate truck identification modules. In this arrangement, the electronics module (not shown in FIGS. 12 and 13) including the memory which generates the truck identification number is disposed in a secure pocket 400 that is molded into a suitable part of the socket assembly housing, for example, the faceplate 15. The electronics module is then permanently affixed to the faceplate 15 by filling the pocket with a sealing material such as potting compound or epoxy 405. This arrangement securely affixes the identification module to the housing and, in turn, the truck thereby preventing the identification module from being removed from the truck. However, the battery 425 which powers the electronics module, is disposed outside of the secure pocket 400 and connected to the electronics module with wires 410. Therefore, the battery 425 can easily be replaced without replacing the entire module.

While the invention has been shown and described with reference to a number of embodiments thereof, it will be recognized by those skilled in the art that various changes in form and detail may be made herein without departing from the spirit and scope of the invention as defined by the appended claims.

What is claimed is:

1. An electrical socket assembly mountable through a hole in a faceplate for establishing electrical connection with a removable plug assembly of a tanker truck overfill prevention system, the socket assembly comprising:
a socket ring that mechanically connects to the plug assembly, the socket ring having a shoulder on its inside diameter;
a contact block body fabricated from an electrically insulating material and having a plurality of contact pins therein which establish electrical contact with the plug assembly, the contact body having a first groove and a second groove located at opposite ends thereof;
a first snap ring seated in the first groove that bears against the shoulder on the socket ring, the contact block body extending through the socket ring and the hole in the faceplate; and
a second snap ring seated in the second groove and bearing against the faceplate in order to mount the socket ring and the contact block body on the faceplate.

2. The electrical socket assembly of claim 1 further comprising an elastomeric O-ring seated in the first groove and sealing against the inside diameter of the socket ring to form a liquid-tight seal between the contact block body and the socket ring.

3. The electrical socket assembly of claim 1 further comprising an additional elastomeric O-ring located between the socket ring and the faceplate in order to form a liquid-tight seal between the socket ring and the faceplate.

4. The electrical socket assembly of claim 1 wherein each of the plurality of electrical contact pins in the contact block body slides into a hole that passes through the contact block body and has a groove with an elastomeric O-ring therein that forms a liquid-tight seal between that pin and the hole.

5. The electrical socket assembly of claim 4 wherein each pin has a longitudinal axis and each pin is fastened in a hole in the contact block body by a set screw that passes through the contact block body in a direction perpendicular to the longitudinal axis of that pin.

6. The electrical socket assembly of claim 1 further comprising a pin located in a recess in the contact block body and extending into a recess in the socket ring and into a recess in the faceplate to prevent relative rotation between the contact block body, the socket ring and the faceplate.

7. The electrical socket assembly of claim 1 wherein the socket ring is fabricated from zinc plated with chrome.

8. An air brake control for an electrical socket assembly mountable on a faceplate and establishing electrical connection with a plug assembly of a tanker truck overfill prevention system, the air brake control comprising:
an air valve having an actuator pin;
an extension housing attached to the air valve having a hollow nipple for attaching the extension housing to the faceplate;
an extension pin slidable within the nipple to contact the actuator pin; and
a spring located between the air valve and the extension pin which maintains a gap between the extension pin and the actuator pin when the air brake control is in an non-actuated state in order to increase the extension pin travel distance needed to actuate the air valve.

9. The air brake control of claim 8 wherein the gap is substantially 1/16 inch.

10. The air brake control of claim 8 wherein the spring surrounds the actuator pin.

11. The air brake control of claim 8 wherein the extension pin has a radial groove therein and wherein the air brake control further comprises an elastomeric O-ring that fits into the groove and forms a seal between the extension pin and the hollow nipple.

12. The air brake control of claim 8 wherein the air valve comprises an air poppet valve.

13. A truck identification module for an electrical socket assembly mountable on a housing and establishing electrical connection with a plug assembly of a tanker truck overfill prevention system, the truck identification module comprising:
an electronics module, including a memory, which generates a truck identification number;
means for permanently attaching the electronics module to the housing; and
a replaceable battery module electrically connected to the electronics module and removeably disposed within the housing.

14. The truck identification module of claim 13 wherein the means for permanently attaching the electronics module to the housing comprises a pocket molded into the housing and wherein the electronics module is disposed within the pocket.

15. The truck identification module of claim 14 wherein the means for permanently attaching the electronics module to the housing further comprises a potting compound that permanently seals the electronics module within the pocket.

16. The truck identification module of claim 14 wherein the battery module is disposed outside of the pocket and connected to the electronics module by wires having separable connectors therein.

17. An electrical socket assembly mountable though a hole in a faceplate for establishing electrical connection with a removable plug assembly of a tanker truck overfill prevention system, the electrical socket assembly comprising:
a zinc ring plated with chrome having at least one slot on its outside diameter for receiving a pin in the plug assembly in order to mechanically connect the ring to the plug assembly; and
a contact block body fabricated from an electrically insulating material, the contact block body extending through the ring and having end that extends through the hole in the faceplate and has a groove therein that receives a snap ring, wherein the snap ring bears against a side of the faceplate opposite from the side on which the ring is located for mechanically fastening the ring to the faceplate.

18. The socket assembly of claim 17 wherein the ring is cast from a ZA-3 zinc material.

19. The socket assembly of claim 18 wherein the ring has a shoulder on its inside diameter and the contact block body has a groove at one end thereof, which receives a snap ring that bears against the shoulder on the ring and prevents the contact block body from passing through the ring.

20. (canceled)
